(19) United States
(12) Patent Application Publication
(10) Pub. No.: US 2012/0195404 A1
(43) Pub. Date: Aug. 2, 2012

(54) X-RAY IMAGING DEVICE AND CONTROL METHOD

(75) Inventor: SATORU OMURA, Chigasaki-shi (JP)

(73) Assignee: CANON KABUSHIKI KAISHA, Tokyo (JP)

(21) Appl. No.: 13/342,236

(22) Filed: Jan. 3, 2012

(30) Foreign Application Priority Data
Jan. 27, 2011 (JP) 2011-015707

(51) Int. Cl. G01N 23/04

(52) U.S. Cl. 378/62

(57) ABSTRACT

An X-ray tube and a grid can be easily aligned. An X-ray imaging device of the present invention includes an imaging unit configured to capture an X-ray image, a first moving unit configured to move a grid relative to an imaging surface of the imaging unit, the grid being configured by lead foil strips disposed in an oblique array, an acquisition unit configured to acquire information indicating a focal position of the grid that has been moved by the first moving unit, and a second moving unit configured to move an X-ray irradiation unit configured to irradiate the imaging unit with X-rays to the focal position of the grid based on the information acquired by the acquisition unit.

### BACKGROUND OF THE INVENTION

1. Field of the Invention

The present invention relates to an X-ray imaging device and a method of controlling the same.

2. Description of the Related Art

Since X-rays generate scatter radiation when passing through a test subject, a grid for removing scatter radiation and sharpening the image is generally built into the imaging unit of an X-ray imaging device.

A grid is a structure in which strips of lead foil, which is a radiation shielding member, are axisymmetrically disposed in an oblique array facing the direction in which the X-ray tube is disposed. For this reason, the X-ray tube needs to be aligned so as to be in correspondence with the oblique array of lead foil strips when X-ray imaging is performed, and Japanese Patent Laid-Open No. 6-154207 discloses a method of measuring the intensity of X-rays that have passed through a grid in X-ray imaging and using the measurement results to perform alignment.

However, Japanese Patent Laid-Open No. 6-154207 has the problem of a high user workload since X-ray imaging for alignment needs to be performed.

Also, there are constraints on the range of movement of the X-ray tube and the imaging unit depending on the imaging environment of the X-ray imaging device, and such constraints need to be taken into consideration when aligning the X-ray tube and the grid. For example, in the case where the test subject lays down on a bed and X-ray imaging is performed on their shoulder joint, the imaging unit needs to be stood upright over the bed, and therefore the bed and the test subject's body become obstacles, and the range of movement of the imaging unit is significantly limited.

In such an imaging environment, there is a very high user workload if alignment is performed based on the method disclosed in Japanese Patent Laid-Open No. 6-154207. Also, if the range of movement of the X-ray tube and the imaging unit is constrained in this way, there is also a limit to the ability to align the X-ray tube and the grid, and obtaining a high-definition image in such a case requires increasing the X-ray dosage in X-ray imaging.

In view of this, there is demand for an X-ray imaging device with a configuration that enables reducing the workload for aligning the X-ray tube and the grid when performing X-ray imaging, and also enables alignment to be realized even when there is a constraint on the range of movement of the X-ray tube and the imaging unit.

### SUMMARY OF THE INVENTION

The present invention has been achieved in light of the above issues.

An X-ray imaging device according to the present invention has the following configuration. The X-ray imaging device includes: an imaging unit configured to capture an X-ray image; a first moving unit configured to move a grid relative to an imaging surface of the imaging unit, the grid being configured by lead foil strips disposed in an oblique array; an acquisition unit configured to acquire information indicating a focal position of the grid that has been moved by the first moving unit; and a second moving unit configured to move an X-ray irradiation unit configured to irradiate the imaging unit with X-rays to the focal position of the grid based on the information acquired by the acquisition unit.

According to the present invention, an X-ray imaging device that enables easily realizing alignment of an X-ray tube and a grid can be provided.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the configuration of an X-ray imaging device according to an embodiment of the present invention.

FIG. 2 is a diagram showing the configuration of an imaging unit of an X-ray imaging device according to a first embodiment of the present invention.

FIG. 3 is a diagram showing the configuration of an imaging unit of an X-ray imaging device according to a second embodiment of the present invention.

FIG. 4 is a flowchart showing a flow of X-ray imaging processing.

FIG. 5 is a diagram showing the configuration of a grid holding frame.

FIG. 6 is a flowchart showing a flow of X-ray imaging processing.

FIG. 7 is a diagram showing the configuration of an imaging unit of an X-ray imaging device according to a seventh embodiment of the present invention.

FIG. 8 is a diagram showing the configuration of an imaging unit of an X-ray imaging device according to an eighth embodiment of the present invention.

### DESCRIPTION OF THE EMBODIMENTS

Embodiments of the present invention will now be described in detail in accordance with the accompanying drawings.

### First Embodiment

1. Configuration of X-Ray Imaging Device

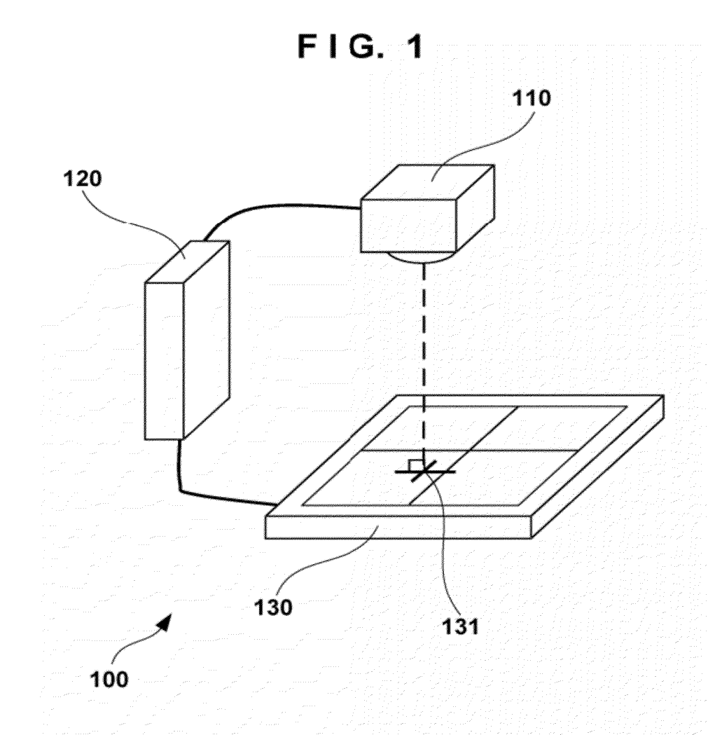

First, a description of the configuration of an X-ray imaging device will be given. FIG. 1 is a diagram showing the configuration of an X-ray imaging device 100 according to an embodiment of the present invention. Note that a description will not be given here for a grid provided over an electronic cassette in an imaging unit since it will be described in detail later.

In FIG. 1, reference numeral 110 denotes an X-ray tube (X-ray irradiation unit) that emits X-rays. Reference numeral 120 denotes a controller that performs overall control of the X-ray imaging device. Reference numeral 130 denotes an electronic cassette that is inside an imaging unit and detects X-rays that have been emitted by the X-ray tube 110 and passed through a test subject.

A mark 131 made on the electronic cassette 130 indicates a line-of-symmetry position over the electronic cassette 130. The line-of-symmetry position is the position of an intersection between lines of symmetry (a line of symmetry in the horizontal axis direction and a line of symmetry in the vertical axis direction) of the strips of lead foil axisymmetrically disposed in an oblique array in the grid (not shown). Note that the X-ray tube 110 is aligned so as to be disposed on a normal line that passes through the line-of-symmetry position where the mark 131 has been made, at a position separated from the line-of-symmetry position by a predetermined distance (a position separated by a distance equal to the focal length).

2. Configuration of Imaging Unit

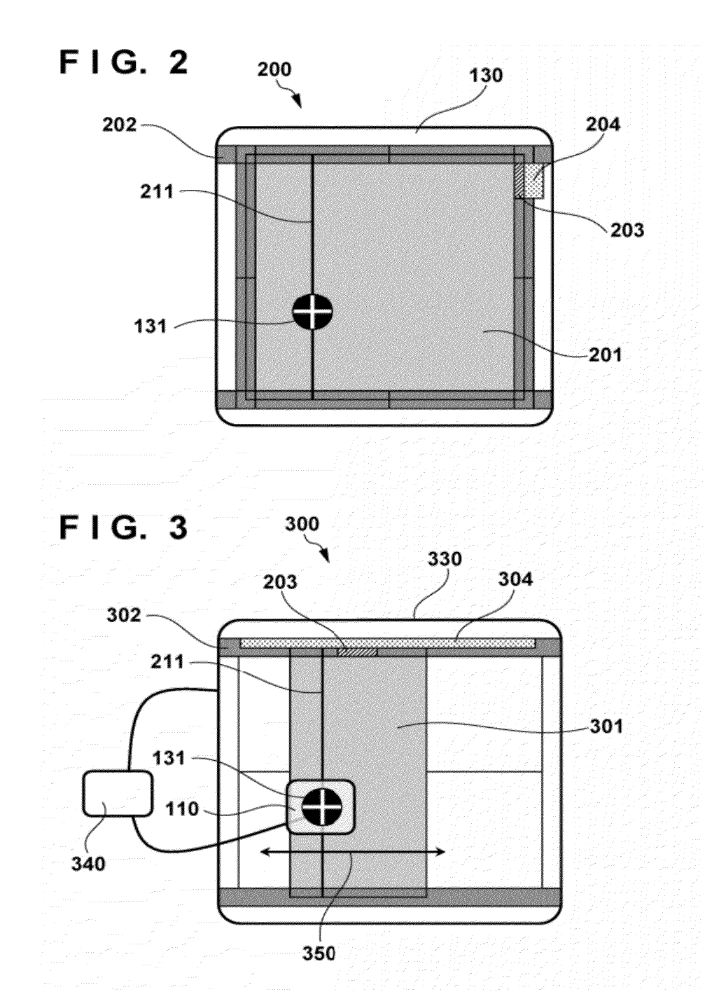

Next is a description of the configuration of the imaging unit of the X-ray imaging device 100. FIG. 2 is a diagram showing the configuration of an imaging unit 200 of the X-ray imaging device 100. As shown in FIG. 2, the imaging unit 200 includes the electronic cassette 130, a grid 201, a grid holding frame 202, a grid information display unit 203, and a grid information detection unit 204.

The grid 201 is a structure for removing scatter radiation, and in the example in FIG. 2, the grid 201 is disposed so as to cover the entirety of an effective imaging region (effective detection region) of the electronic cassette 130. There are various types of grids 201 that differ with respect to the focal length to the X-ray tube 110, external dimensions, the line-of-symmetry position, and the like.

Accordingly, selecting the optimum grid according to the imaging environment of the X-ray imaging device 100 enables realizing alignment of the X-ray tube and the grid even in the case where there is a constraint on the range of movement of the imaging unit.

The grid holding frame 202 is a frame that holds the grid 201, and is included in the electronic cassette 130 (or mounted by external attachment). Note that in the present embodiment, the grid holding frame 202 holds the outer edge portion of the grid 201. Accordingly, the positional relationship between the grid 201 and the electronic cassette 130 is fixed due to the grid 201 being held by the grid holding frame 202.

The grid information display unit 203 is a display unit provided on the grid 201 for displaying a grid ID corresponding to the type of grid and information indicating characteristics of the grid 201, such as information indicating the focal length, external dimensions, and line-of-symmetry position.

The grid information detection unit 204 is a detection unit that detects the information displayed in the grid information display unit 203, and is disposed so as to be able to detect the information displayed in the grid information display unit 203 when the grid 201 is held by the grid holding frame 202.

If a grid ID has been detected by the grid information detection unit 204, the electronic cassette 130 references a position information table that describes the correspondence between the detected grid ID and information indicating a focal length, external dimensions, and line-of-symmetry position. This enables the electronic cassette 130 to calculate the line-of-symmetry position relative to the electronic cassette 130. Also, if information indicating a focal length, external dimensions, and line-of-symmetry position has been detected by the grid information detection unit 204, the electronic cassette 130 calculates the line-of-symmetry position relative to the electronic cassette 130 based on the detected information.

Reference numeral 211 denotes a line of symmetry of the strips of lead foil axisymmetrically disposed in an oblique array in the grid 201. The line of symmetry 211 is marked on the surface of the grid 201, and the user can visually align the X-ray tube 110 while viewing the line of symmetry 211.

3. Alignment of X-Ray Tube and Grid

As described with reference to FIG. 2, the X-ray imaging device 100 of the present embodiment includes the grid holding frame 202, and various types of grids 201 can be removably attached to the electronic cassette 130. Accordingly, alignment can be easily realized by selecting the optimum grid 201 according to the imaging environment of the X-ray imaging device 100, attaching the selected grid 201 to the grid holding frame 202, and calculating a line-of-symmetry position over the electronic cassette 130 in accordance with the grid 201.

Alignment of the X-ray tube 110 and the grid 201 is performed by the controller 120 as described below.

First, information indicating the line-of-symmetry position relative to the electronic cassette 130, which was calculated by the electronic cassette 130 is transmitted to the controller 120. Position information of the electronic cassette 130 is also transmitted to the controller 120. Similarly, position information of the X-ray tube 110 is also transmitted to the controller 120.

The controller 120 calculates a movement amount for aligning the X-ray tube 110 with the grid 201 based on the information that was transmitted, and completes the alignment by causing the X-ray tube 110 to move based on the movement amount.

As is clear from the above description, in the configuration of the present embodiment, various types of grids having different focal lengths, external dimensions, and line-of-symmetry positions can be removably attached to the electronic cassette. Accordingly, even in the case where the range of movement of the imaging unit is limited, alignment of the X-ray tube and the grid can be realized by selecting the optimum grid.

As a result, it is possible to avoid the conventional situation in which the X-ray tube and the grid cannot be sufficiently aligned due to a constraint on the range of movement of the imaging unit, and the X-ray dosage is increased as a countermeasure.

Also, in the configuration of the present embodiment, the grid information display unit and the grid information detection unit are provided such that the X-ray tube 110 can be automatically aligned with the selected grid 201. This enables detecting information for calculating the line-of-symmetry position of the grid 201 relative to the electronic cassette 130, and enables automatically aligning the X-ray tube 110 so as to correspond to the selected grid 201.

As a result, the X-ray tube and the grid can be easily aligned.

### Second Embodiment

In the configuration of the first embodiment, the line-of-symmetry position relative to the electronic cassette 130 is calculated based on the information displayed in the grid information display unit 203, but the present invention is not limited to this. For example, a configuration is possible in which a line of symmetry detection unit that directly detects the line of symmetry 211 marked on the surface of the grid 201 is provided, and the line-of-symmetry position relative to the electronic cassette is calculated by the line of symmetry 211 being detected by the line of symmetry detection unit.

### Third Embodiment

In the configuration of the first embodiment, the line-of-symmetry position is changed by changing the type of grid, and the X-ray tube is aligned with the changed line-of-symmetry position. However, the present invention is not limited to this. For example, a configuration is possible in which the grid itself is moved in a predetermined direction over the electronic cassette, and the X-ray tube is aligned in conformity with the movement of the grid. The following is a detailed description of the present embodiment.

1. Configuration of Imaging Unit

FIG. 3 is a diagram showing the configuration of an imaging unit 300 of an X-ray imaging device according to the present embodiment. In FIG. 3, reference numeral 340 denotes a position measurer that calculates the positional relationship between the X-ray tube 110 and an electronic cassette 330.

The position measurer 340 calculates the positional relationship between the X-ray tube 110 and the electronic cassette 330 by detecting the length of arms that hold the X-ray tube 110 and the electronic cassette 330. Alternatively, the positional relationship between the X-ray tube 110 and the electronic cassette 330 is calculated by a relative distance and a relative angle between the X-ray tube 110 and the electronic cassette 330 being detected by an ultrasound sensor.

Reference numeral 301 denotes a grid, and in the present embodiment, the grid 301 is formed in a strip shape so as to cover only part of the effective imaging region of the electronic cassette 330. Reference numeral 302 denotes a grid holding frame that slidably holds the opposing short sides of the strip-shaped grid 301. Accordingly, the grid 301 can be moved in the direction of an arrow 350. Note that the grid holding frame 302 is configured so as to enable the insertion of a stopper that obstructs the movement of the grid 301 in the arrow 350 direction, and this configuration enables fixing the grid 301 at an arbitrary position in the arrow 350 direction.

Reference numeral 304 denotes a grid information detection unit that is provided in the entire range of the arrow 350 direction so as to be able to detect the grid information display unit 203 provided on the grid 301 regardless of what position the grid 301 is fixed at in the arrow 350 direction.

Note that the grid information detection unit 304 not only detects the grid information display unit 203, but also determines the position at which the grid information display unit 203 was detected (the position of at least one corner of the grid 301). Accordingly, the position of the grid 301 in the arrow 350 direction can also be detected.

Note that the grid information detection unit 304 does not necessarily need to be configured so as to determine the position of at least one corner of the grid 301. Alternatively, a configuration is possible in which the grid holding frame 302 is provided with a separate line sensor, and the line sensor detects the position in the arrow 350 direction of the grid 301 that is held in the grid holding frame 302.

Reference numeral 330 denotes an electronic cassette. In the case where grid ID information has been detected by the grid information detection unit 304, the electronic cassette 330 acquires information indicating the focal length, external dimensions, and line-of-symmetry position by referencing a position information table. Furthermore, the electronic cassette 330 acquires the position of the grid 301 in the arrow 350 direction that was detected by the grid information detection unit 304 or the line sensor. The electronic cassette 330 then calculates the line-of-symmetry position relative to the electronic cassette 330 based on the acquired information.

Alternatively, in the case where information indicating the focal length, external dimensions, and line-of-symmetry position has been detected by the grid information detection unit 304, such information is acquired. Furthermore, the position of the grid 301 in the arrow 350 direction that was detected by the grid information detection unit 304 or the line sensor is acquired. The line-of-symmetry position relative to the electronic cassette 330 is then calculated based on the acquired information.

Furthermore, the electronic cassette 330 calculates a range of overlapping of the grid 301 and the effective imaging region of the electronic cassette 330 based on the external dimensions of the grid 301 and the position of the grid 301 in the arrow 350 direction that were acquired.

2. Alignment of X-Ray Tube and Grid and Aperture Adjustment

Similarly to the first embodiment, alignment of the X-ray tube 110 is performed by the controller 120 as described below.

First, information indicating the line-of-symmetry position relative to the electronic cassette 330, which was calculated by the electronic cassette 330, is transmitted to the controller 120. Position information of the electronic cassette 330 is also transmitted to the controller 120. Position information of the X-ray tube 110 is furthermore transmitted to the controller 120.

The controller 120 calculates a movement amount for aligning the X-ray tube 110 with the grid 301 based on the information that was transmitted, and causes the position of the X-ray tube 110 to move based on the movement amount. This completes the alignment of the X-ray tube 110 and the grid 301.

Furthermore, in the present embodiment, the range of overlapping of the grid 301 and the effective imaging region of the electronic cassette 330 that was calculated by the electronic cassette 330 and the focal length that was acquired by the electronic cassette 330 are transmitted to the controller 120. The controller 120 adjusts the aperture that defines the irradiation range of X-rays emitted by the X-ray tube, based on the range of overlapping and the focal length that were transmitted from the electronic cassette 330.

This avoids the situation in which X-rays are emitted in a range outside the range of overlapping of the grid 301 and the effective imaging region of the electronic cassette 330, thus enabling reducing the test subject exposure dose.

3. Flow of X-Ray Imaging Processing

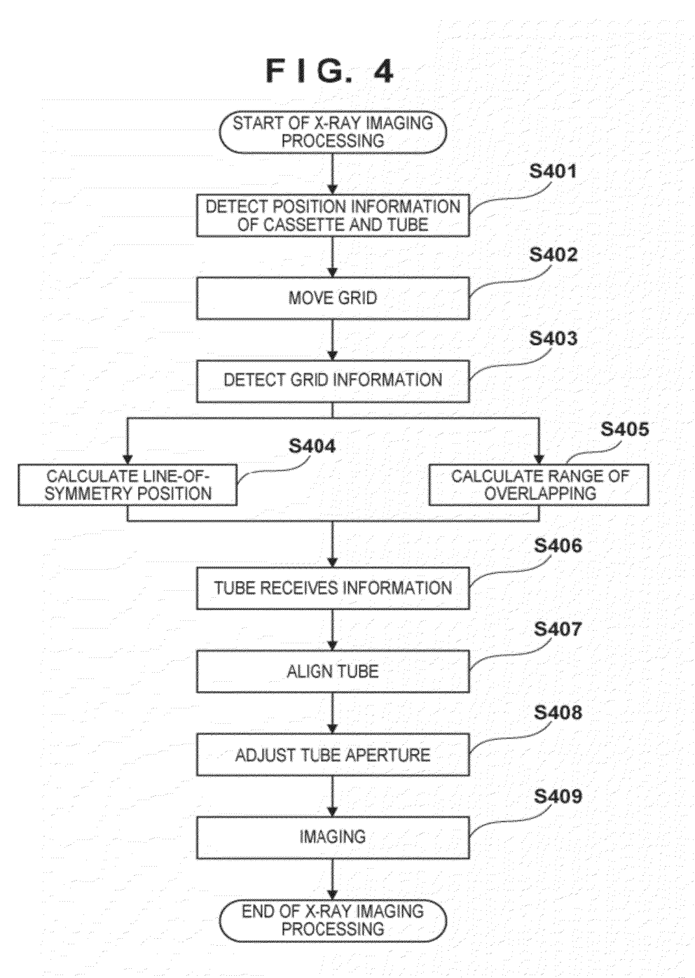

Next is a description of the flow of X-ray imaging processing performed by the X-ray imaging device 100 of the present embodiment. FIG. 4 is a flowchart showing the flow of X-ray imaging processing performed by the X-ray imaging device 100 of the present embodiment.

As shown in FIG. 4, in step S401, the position measurer 340 detects position information of the electronic cassette 330 and the X-ray tube 110. In step S402, the user moves the grid 301 to a desired position while giving consideration to the position of the test subject site to be imaged.

In step S403, the grid information detection unit 304 detects the information displayed in the grid information display unit 203.

In step S404, the line-of-symmetry position relative to the electronic cassette 330 is calculated based on the information detected in step S403. Also, in step S405, the region of overlapping of the grid 301 and the effective imaging region of the electronic cassette 330 is calculated based on the information detected in step S403.

In step S406, the controller 120 receives the detection result obtained in step S401 and the calculation result obtained in step S404, and calculates a movement amount for the X-ray tube 110 for alignment with the grid 301. The calculated movement amount is then transmitted to the X-ray tube 110.

In step S407, the X-ray tube 110 moves based on the movement amount transmitted in step S406, thus completing alignment of the X-ray tube 110 and the grid 301.

In step S408, the controller 120 calculates the aperture to be used in X-ray irradiation based on the calculated result obtained in step S405, and adjusts the aperture based on the aperture calculation result.

When the alignment in step S407 and the aperture adjustment in step S409 have been completed, the procedure moves to step S409 in which X-ray imaging is performed.

As is clear from the above description, in the configuration of the present embodiment, the grid 301 is movably attached to the electronic cassette 330. Accordingly, even in the case where the range of movement of the imaging unit is limited, alignment of the X-ray tube and the grid can be realized by moving the grid to the optimum position.

As a result, it is possible to avoid the conventional situation in which the X-ray tube and the grid cannot be sufficiently aligned due to a constraint on the range of movement of the imaging unit, and the X-ray dosage is increased as a countermeasure.

Also, in the configuration of the present embodiment, the grid information display unit and the grid information detection unit are provided, and after the grid 301 has been moved, the X-ray tube 110 is aligned with the moved grid 301.

Accordingly, while the test subject imaging orientation is being determined, alignment of the grid 301 and the X-ray tube 110 can be performed at the same time by merely moving the grid 301 to the appropriate position.

As a result, the X-ray tube and the grid can be aligned easily.

### Fourth Embodiment

In the configuration of the third embodiment, the grid information detection unit 304 detects the position of the grid 301 in the arrow 350 direction and the information displayed in the grid information display unit 203, and the line-of-symmetry of the grid 301 relative to the electronic cassette 330 is calculated based on the detection result.

However, the present invention is not limited to this, and a configuration is possible in which the grid information detection unit 304 is provided with the function of detecting the line of symmetry 211 marked on the surface of the grid 301. Accordingly, the line-of-symmetry position relative to the electronic cassette can be calculated based on the position of the grid 301 in the arrow 350 direction and the line of symmetry 211 that was detected by the grid information detection unit 304.

### Fifth Embodiment

In the configurations of the third and fourth embodiments, the grid holding frame 302 is configured such that the grid 301 is held so as to be able to move in the arrow 350 direction, and the user manually moves the grid 301 in the arrow 350 direction, but the present invention is not limited to this.

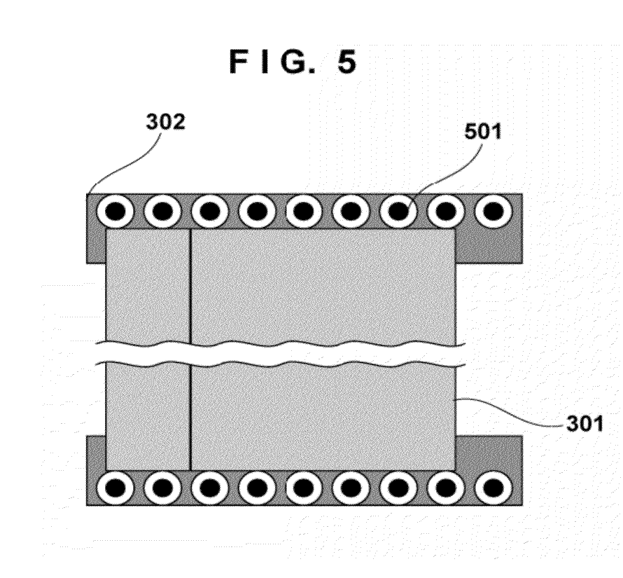

For example, a configuration is possible in which, as shown in FIG. 5, multiple rollers 501 are provided on the grid holding frame 302, the side faces of the grid 301 on the short end sides are held by the rollers 501, and the rotation of the rollers 501 is controlled.

This configuration enables the grid 301 to be automatically moved to a desired position in the arrow 350 direction. Also, a configuration is possible in which the position of the grid 301 in the arrow 350 direction is calculated based on the rotation direction and rotation amount of the rollers 501 instead of being detected by the grid information detection unit 304.

### Sixth Embodiment

In the configuration of the third embodiment, the grid 301 is moved, and thereafter the X-ray tube 110 is aligned with the line-of-symmetry position of the moved grid 301, but the present invention is not limited to this. For example, a configuration is possible in which the X-ray tube 110 is moved, and thereafter the line-of-symmetry position of the grid 301 is aligned with the position of the X-ray tube 110.

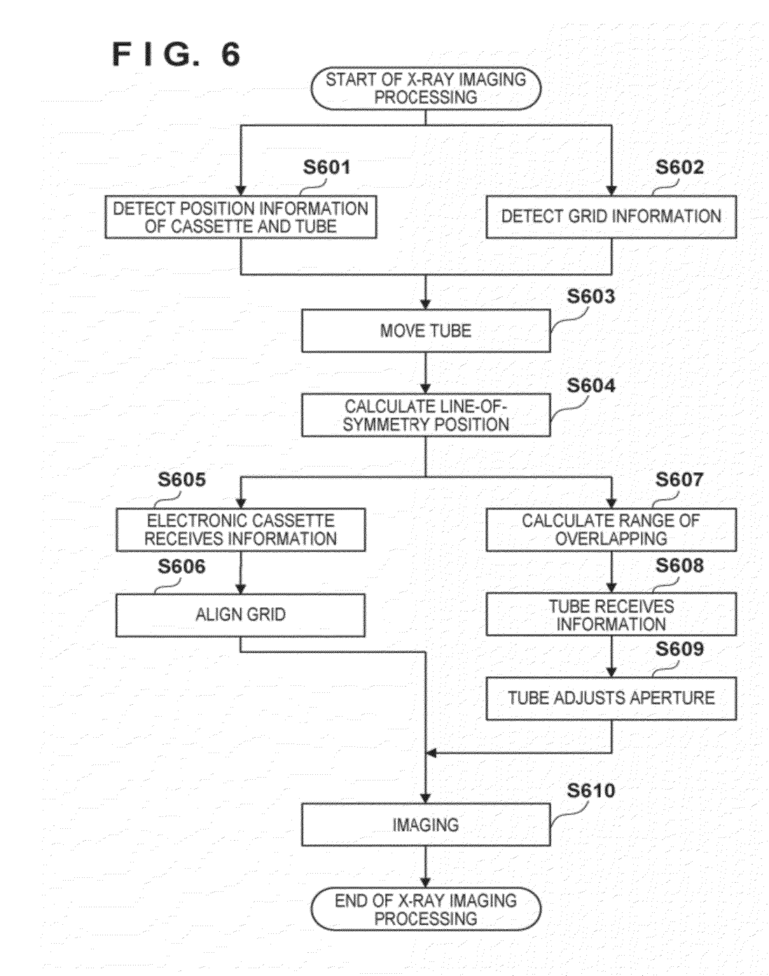

FIG. 6 is a flowchart showing the flow of X-ray imaging processing performed by the X-ray imaging device 100 of the present embodiment.

As shown in FIG. 6, in step S601, the position measurer 340 detects position information of the X-ray tube 110 and the electronic cassette 330. In step S602, the grid information detection unit 304 detects the information displayed in the grid information display unit 203 and detects the position of the grid 301 in the arrow 350 direction.

In step S603, the X-ray tube 110 is caused to move to the appropriate position. In step S604, the position measurer 340 again detects position information of the X-ray tube 110, and the line-of-symmetry position relative to the electronic cassette 330 is calculated based on the information detected in step S602.

In step S605, the detected position information and calculated line-of-symmetry position of step S604 are received, and in step S606, alignment of the grid 301 is performed by causing the imaging unit 300 to move.

Also, at the same time, in step S607 a region of overlapping of the grid 301 and the effective imaging region of the electronic cassette 330 is calculated based on the information detected in step S602.

In step S608, the region of overlapping that was calculated in step S607 is received, and in step S609, the controller 120 adjusts the aperture of the X-ray tube 110 based on the received information.

When alignment of the grid 301 in step S606 has been completed, and adjustment of the tube aperture in step S609 has been completed, X-ray imaging is performed in step S610.

As is clear from the above description, according to the present embodiment, the X-ray tube 110 is caused to move, and thereafter the line-of-symmetry position of the grid 301 can be moved so as to be aligned with the position of the moved X-ray tube 110.

### Seventh Embodiment

In the configuration of the fifth embodiment, a grid having a dimension in one direction that is short relative to the effective imaging region of the electronic cassette is attached to the electronic cassette so as to be above to move in that one direction.

However, the present invention is not limited to this, and a configuration is possible in which, for example, a grid having dimensions in two directions that are short relative to the effective imaging region of the electronic cassette is attached to the electronic cassette so as to be above to move in those two directions. The following is a description of the present embodiment.

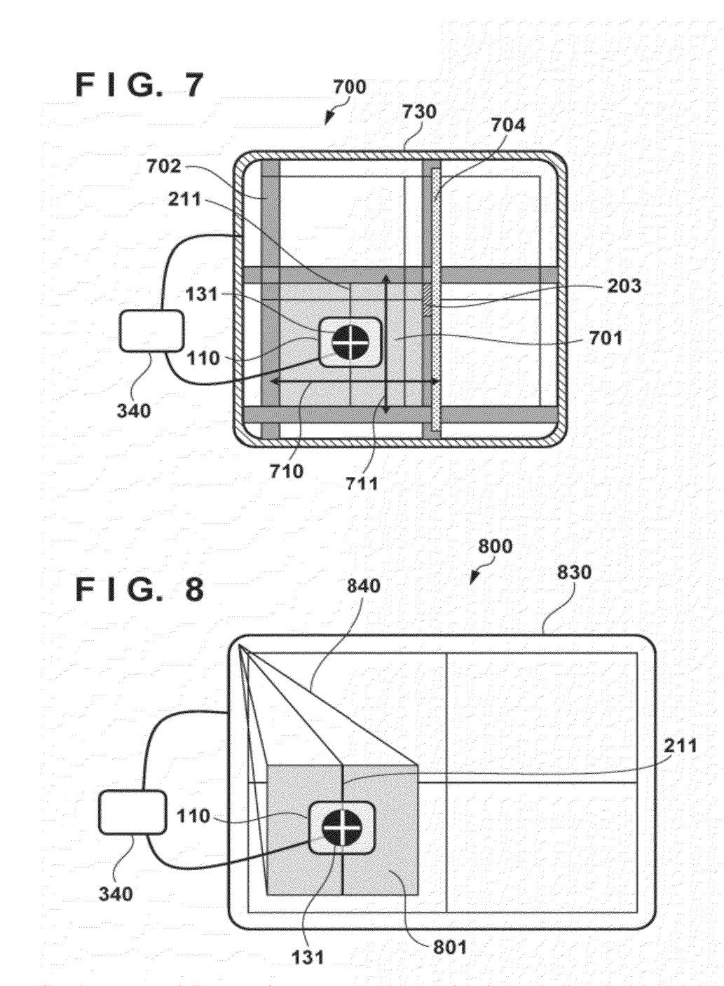

FIG. 7 is a diagram showing the configuration of an imaging unit 700 of an X-ray imaging device according to the present embodiment. In FIG. 7, reference numeral 701 denotes a grid, and in the present embodiment, the grid 701 is formed so as to cover only part of the effective imaging region of an electronic cassette 730. Reference numeral 702 denotes a grid holding frame that movably holds the four sides of the grid 701. Note that the grid holding frame 702 is configured such that intersection positions can be changed, and therefore the grid 701 can be moved in the direction of an arrow 710 and in the direction of an arrow 711.

Note that the grid holding frame 702 is configured such that the intersection positions can be fixed by a pin being placed therein. Also, the grid holding frame 702 is configured so as to enable the insertion of a stopper that obstructs the movement of the grid 701 in the arrow 710 and arrow 711 directions, and this configuration enables fixing the grid 701 at an arbitrary position in the arrow 710 and arrow 711 directions.

Note that similarly to the fifth embodiment, in the case of a configuration in which the grid 701 can be automatically moved to a desired position in the arrow 710 and arrow 711 directions, positioning of the grid 701 is performed by controlling the rotation of rollers disposed at intersection portions of the grid holding frame 702.

A grid information detection unit 704 is provided in the entire range of the arrow 711 direction so as to be able to detect the information displayed in the grid information display unit 203 provided on the grid 701 regardless of what position the grid 701 is fixed at in the arrow 711 direction. Note that the grid information detection unit 704 also detects the position of the grid 701 in the arrow 710 and arrow 711 directions by furthermore determining the position at which the grid information display unit was detected (the positions of a set of opposing corners of the grid 701).

In the case where grid ID information has been detected by the grid information detection unit 704, the electronic cassette 730 acquires information indicating the focal length, external dimensions, and line-of-symmetry position by referencing a position information table. Furthermore, the positions of the grid 701 in the arrow 710 and arrow 711 directions that were detected by the grid information detection unit 704 are acquired. The line-of-symmetry position relative to the electronic cassette 730 is then calculated based on the acquired positions.

Alternatively, in the case where information indicating the focal length, external dimensions, and line-of-symmetry position has been detected by the grid information detection unit 704, such information is acquired. Furthermore, the positions of the grid 701 in the arrow 710 and arrow 711 directions that were detected by the grid information detection unit 704 are acquired. The line-of-symmetry position relative to the electronic cassette 730 is then calculated based on the acquired positions.

Furthermore, the electronic cassette 730 calculates the range of overlapping of the grid 701 and the effective imaging region of the electronic cassette 730 based on the external dimensions of the grid 701 and the positions of the grid 701 in the arrow 710 and arrow 711 directions that were acquired.

As is clear from the above description, the present invention enables easily aligning the X-ray tube and the grid even in the case of using a grid having dimensions in two directions that are smaller than the effective imaging region of the electronic cassette.

### Eighth Embodiment

In the configurations of the first to seventh embodiments, the position of a grid is detected by providing a grid holding frame over an electronic cassette, and providing the grid holding frame with a grid information detection unit or a line sensor. However, the present invention is not limited to this.

FIG. 8 is a diagram showing the configuration of an imaging unit 800 of an X-ray imaging device according to an eighth embodiment of the present invention. In FIG. 8, 840 denotes string-shaped measuring lines for measuring the distance from an outer end portion of an electronic cassette 830 to a target position and an angle.

An outlet for the measuring lines 840 and a winding mechanism for winding up and storing the measuring lines 840 are provided in the outer end portion of the electronic cassette 830. Furthermore, an angle sensor for detecting the direction in which the measuring lines 840 are being pulled is provided in the outlet for the measuring lines 840. Accordingly, the direction from the outlet for the measuring lines 840 is detected. The winding mechanism can also detect the number of rotations, and therefore can detect the length of the lines outside the measuring line outlet.

As shown in FIG. 8, the measuring lines 840 are connected to three corners of the exterior of a grid 801 and to an end of the line of symmetry 211 of the grid 801. According to this configuration, the electronic cassette 830 can calculate the positions of the external shape and a line of symmetry of the grid 801.

Note that a configuration is possible in which the placement angle of the grid 801 relative to the electronic cassette 830 is calculated, and the imaging unit 800 is provided with a display unit that displays the calculation result.

According to this configuration, the grid 801 can be freely disposed over the surface of the electronic cassette 830. Also, even in the case where the electronic cassette 830 is formed in a rectangular shape, and there is a desire to switch the short sides and long sides, this can be realized by merely rotating the grid by 90 degrees, thus improving user-friendliness.

As is clear from the above description, the present invention enables easily aligning an X-ray tube even when a grid holding frame is not used in order to movably provide a grid having dimensions in two directions that are smaller than the effective imaging region of an electronic cassette.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-015707 filed Jan. 27, 2011, which is hereby incorporated by reference herein in its entirety.

What is claimed is:

1. An X-ray imaging device comprising:
an imaging unit configured to capture an X-ray image;
a first moving unit configured to move a grid relative to an imaging surface of the imaging unit, the grid being configured by lead foil strips disposed in an oblique array;
an acquisition unit configured to acquire information indicating a focal position of the grid that has been moved by the first moving unit; and
a second moving unit configured to move an X-ray irradiation unit configured to irradiate the imaging unit with X-rays to the focal position of the grid based on the information acquired by the acquisition unit.

2. The X-ray imaging device according to claim 1,
wherein the acquisition unit acquires information used for calculating the position relative to the imaging surface of a line of symmetry of the lead foil strips axisymmetrically disposed in an oblique array in the grid, and a focal length of the X-ray irradiation unit relative to the grid.

3. The X-ray imaging device according to claim 1, further comprising:
a holding unit configured to be able to hold a plurality of types of grids that are different with respect to any of the position of a line of symmetry of the lead foil strips axisymmetrically disposed in an oblique array in the grid, a focal length of the X-ray irradiation unit, and an external dimension.

4. The X-ray imaging device according to claim 2,
wherein the information used for calculating the position relative to the imaging surface includes the position of a line of symmetry of the lead foil strips axisymmetrically disposed in an oblique array in the grid and an external dimension of the grid.

5. The X-ray imaging device according to claim 2, further comprising:
a holding unit configured to be able to hold the grid at an arbitrary position relative to the imaging surface,
wherein the information used for calculating the position relative to the imaging surface further includes the position of the grid relative to the imaging surface.

6. The X-ray imaging device according to claim 2,
wherein the acquisition unit furthermore calculates a range of overlapping of the grid and an effective detection region of the imaging surface based on the information used for calculating the position relative to the imaging surface, and
an X-ray irradiation range of the X-ray irradiation unit is adjusted based on the range of overlapping calculated by the acquisition unit and the focal length acquired by the acquisition unit.

7. An X-ray imaging device comprising:
an imaging unit configured to capture an X-ray image;
a first moving unit configured to move a grid relative to an imaging surface of the imaging unit, the grid being configured by lead foil strips disposed in an oblique array;
an acquisition unit configured to acquire position information of an X-ray irradiation unit configured to irradiate the imaging unit with X-rays; and
a second moving unit configured to move the X-ray irradiation unit based on the position information acquired by the acquisition unit.

8. An X-ray imaging device control method comprising:
an imaging step of capturing an X-ray image;
a first moving step of moving a grid relative to an imaging surface of an imaging unit, the grid being configured by lead foil strips disposed in an oblique array;
an acquisition step of acquiring information indicating a focal position of the grid that has been moved in the first moving step; and
a second moving step of moving an X-ray irradiation unit configured to irradiate the imaging unit with X-rays to the focal position of the grid based on the information acquired in the acquisition step.

9. An X-ray imaging device control method comprising:
an imaging step of capturing an X-ray image;
a first moving step of moving a grid relative to an imaging surface of an imaging unit, the grid being configured by lead foil strips disposed in an oblique array;
an acquisition step of acquiring position information of an X-ray irradiation unit configured to emit X-rays in the imaging step; and
a second moving step of moving the X-ray irradiation unit based on the position information acquired in the acquisition step.

10. A non-transitory computer-readable medium encoded with a computer readable control program which, when executed by a processor, will cause a computer to execute the control method according to claim 8.

11. A non-transitory computer-readable medium encoded with a computer readable control program which, when executed by a processor, will cause a computer to execute the control method according to claim 9.
